(19) United States
(12) Patent Application Publication
(10) Pub. No.: US 2012/0287490 A1
(43) Pub. Date: Nov. 15, 2012

(54) Displaying 3D Imaging Sensor Data on a Hogel Light Modulator

(75) Inventors: Michael A. Klug, Austin, TX (US); Thomas L. Bumett, III, Austin, TX (US); Michael E. Weiblen, Black Hawk, CO (US)

(73) Assignee: Zebra Imaging, Inc., Austin, TX (US)

(21) Appl. No.: 13/291,091

(22) Filed: Nov. 7, 2011

Related U.S. Application Data
(60) Provisional application No. 61/410,763, filed on Nov. 5, 2010.

(51) Int. Cl. G03H 1/08

(52) U.S. Cl. 359/9

(57) ABSTRACT

Methods and systems for displaying 3D imaging data, including providing 3D imaging sensor data, processing the 3D imaging sensor data, the processing being configured to modify the 3D imaging sensor data into a modified format suitable for a hogel light modulator, and providing the modified 3D imaging data to the hogel light modulator.

### A. PRIORITY CLAIM

This patent application claims priority from previously filed provisional patent application filed on Nov. 5, 2010, titled “Displaying 3D Video”, by Michael A. Klug, No. 61/410,763. The above-referenced patent application is hereby incorporated by reference herein in its entirety.

### B. BACKGROUND

The invention relates generally to the field of near real-time displaying of scanned 3D scenery on a hogel light modulator.

### C. SUMMARY

In one respect, disclosed is a method for displaying 3D imaging sensor data, the method including providing 3D imaging sensor data, processing the 3D imaging sensor data, the processing being configured to modify the 3D imaging sensor data into a modified format suitable for a hogel light modulator, and providing the modified 3D imaging data to the hogel light modulator.

In another respect, disclosed is a system for displaying 3D imaging sensor data, the system comprising one or more processors, one or more memory units coupled to the one or more processors, the system being configured to provide 3D imaging sensor data, process the 3D imaging sensor data, the processing being configured to modify the 3D imaging sensor data into a modified format suitable for a hogel light modulator, and provide the modified 3D imaging data to the hogel light modulator.

Numerous additional embodiments are also possible.

### D. BRIEF DESCRIPTION OF THE DRAWINGS

Other objects and advantages of the invention may become apparent upon reading the detailed description and upon reference to the accompanying drawings.

FIG. 1 is a block diagram illustrating a system for processing 3D imaging sensor data, in accordance with some embodiments.

FIG. 2 is a block diagram illustrating an alternative system for processing 3D imaging sensor data, in accordance with some embodiments.

FIG. 3 is diagram illustrating a buffer for storing and retrieving 3D imaging sensor data, in accordance with some embodiments.

FIG. 4 is a flow diagram illustrating a method for processing 3D imaging sensor data, in accordance with some embodiments.

FIG. 5 is a flow diagram illustrating an alternative method for processing 3D imaging sensor data, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### E. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

Those of skill will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Those of skill in the art may implement the described functionality in varying ways for each particular application, but such implementation decisions should not be interpreted as causing a departure from the scope of the present invention.

Systems and methods are disclosed for scanning a 3D scenery in near real-time and providing the 3D data for display on a hogel light modulator. In some embodiments, the scanning of the 3D scenery may be performed using the near real-time LIDAR 3D digitization systems (“NRT-LIDAR”). NRT-LIDAR systems may provide a stream of 3D-position point information that may be transmitted to a 3D display such as a hogel light modulator. In alternative embodiments, other systems may be used to collect the 3D imaging data, such as light outside the visible range (millimeter wavelengths), MRI, CT, Multi-spectral (e.g. IR) as well as RADAR, SAR, etc. In yet other embodiments, sound (SONAR) or other types of sensors may be used.

In addition, the collection may be accomplished using instantaneous, “flash” recording to, in essence, stop-action or show a single instance of time. In another approach, a series of flashes and or scans, overlapped or not, could be assembled and accumulated on the display in 3D to result in a higher fidelity representation of the scene and/or a broader imaged area. Thus, 3D positions that didn't provide reflectance/transmittance in the first scan or flash might do so in a second or third, and the superposition of the resultant points may produce a more complete 3D representation visually on the display.

In one embodiment, one or more sensor reading or reading from different sensors may be combined in order to obtain a higher quality image.

In addition, accumulation may be used for tracking in 3D, visually, on the display, such as a bird flying across successive frames or a volleyball player moving through space to spike a ball—the arc of her jump may be shown by displaying the successive 3D frames on the display simultaneously to accomplish a “3D blur” or a 3D strobe sequence.

In some embodiments, the transmission may be accomplished using a tethered line or wireless transceivers, using the UDP Ethernet protocol, for example.

A host computer, connected to the hogel light modulator may be configured to receive the 3D data stream. In some embodiments, the host computer may be executing virtualization software configured to receive the 3D data stream and to convert the 3D data to OpenGL or other supported higher-level 3D computer graphics language that may be accepted by the hogel light modulator. The hogel light modulator may then generate a 3D image of the 3D data acquired by the 3D scanner.

In some embodiments, the 3D image may update quickly with little lag. The system may be used for collaborative planning and monitoring, enhanced awareness of the imaged space, and remote volumetric visualization of hazardous areas.

In some embodiments, the 3D scanner may be static where the sensor dwells in a single location constantly transmitting 3D data back to a hogel light modulator for hazard identification, tracking, and general situational overview, for example. For moving scanner/sensor applications in which the 3D coordinates of the surroundings (such as buildings, caves, and other structural interiors, and remotely-operated motion platforms), the system may be used to pre-view and map potential hazards prior to manned investigations, for example. In some embodiments, the system may be used for intelligence gathering, post-catastrophic structural damage assessment. For entertainment applications, the system may be used for live digitization of sporting events where 3D is a factor such as for soccer, tennis, volleyball, football, basketball, BMX, motocross, etc. The sensor/display combination may provide a means by which to collectively view the events in a social environment, with a more complete picture of the space.

In other embodiments, the system may be used as an on-board navigational display, providing a moving viewpoint update of potential physical hazards on a ship, personnel carrier, or helicopter, particularly in low visibility situations. In general, a dynamic 3D display providing near real-time volumetric views of a space may enable the viewer to see details they might miss with the limited perspectives offered by discrete 2D cameras.

Hogel light modulators may provide full-parallax and when oriented horizontally (in one configuration), the modulators naturally couple with the azimuthal, 360 degree acquisition of the system such as LIDAR. Representations as point clouds result in data gaps that sometimes enhances the perception of the scene (including “shadows”) that are straightforward for the viewer to intuit.

In embodiments where the 3D information captured is converted to openGL, immediate mode drawing as well as display lists may be considered. Typically, immediate mode drawing can very expensive for applications that have new vertices every frame. In an application where the data does not change on a per frame basis, instructions and geometry may be wrapped within OpenGL display lists to allow the graphics card to cache the operations locally. Typically, in applications where the data does change every frame, display lists may not be created because the overhead of creating and deleting unique display lists every frame may degrade performance. However, within a hogel light modulator, since the internal GPUs used for rendering service multiple modulators, and each hogel generated is in fact a completely separate render, the use of display lists may result in significant performance gains even when the parent application considers the geometry unique per frame.

In some embodiments, display listing may compile drawing commands onto the graphics processing unit. The display list may then be invoked from the CPU with a single OpenGL function, rather than all the scene's draw commands being redispatched by the CPU to the graphics processing unit. When a scene is to be drawn by a single GPU, the cost of generating the display list may be more than made up by the increased draw performance.

In some embodiments, special extensions to OpenGL, for example, may be added to the display listing process. In some embodiments, the special extensions may allow additional flexibility in how the optimization may be implemented, and may also help minimize modifications to the end-user application.

In some embodiments, a FIFO buffer may be implemented. In some embodiments, the buffer may be implemented as a circular buffer where the oldest values may be discarded.

In some embodiments, the received 3D imaging sensor data may be received in sequential time frames as the data is being captured. Each of the frames may be stored in the buffer as the frames become available, with a point tracking the position where the next frame is to be stored.

One of more processing threads may each keep pointer tracking a position where each thread is reading frames from the buffer for processing. In some embodiments, the one or more processing threads may read and process one frame from the buffer at a time. In other embodiments, the processing threads may implement a sliding window in time over which the read and process data. Thus, frames read from within a sliding time windows may be averaged (and weighted if necessary) to accomplish different effects on the viewing experience. In other embodiments, various types of filters (such as a low-pass and a high-pass filter) may be applied to the sliding window.

In some embodiments, instead of providing the data to a hogel light modulator, the data may be stored for later use.

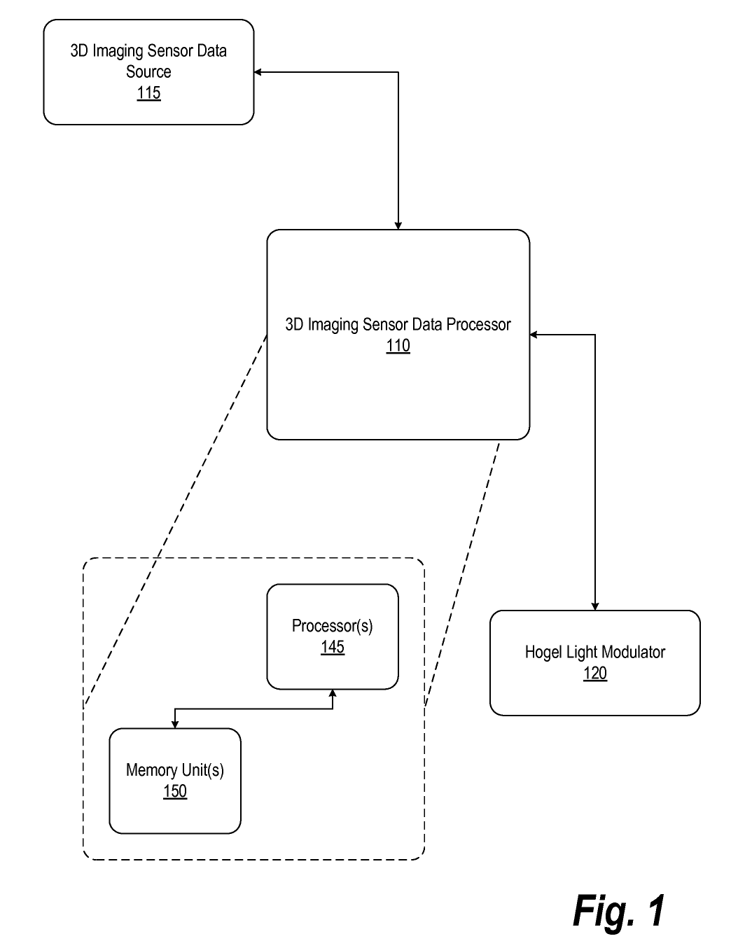

FIG. 1 is a block diagram illustrating a system for processing 3D imaging sensor data, in accordance with some embodiments.

In some embodiments, 3D imaging sensor data source 115 may be configured to provide 3D imaging sensor data. The 3D imaging sensor data may point cloud data, for example. Various types of sensors may be used to obtain the data as described above. In some embodiments, the data may be provided in real time or near real time, may be simulated, or may be read from previously stored data.

In some embodiments, 3D imaging data processor 110 is configured to receive and process 3D imaging data from 3D imaging sensor data source 115. In some embodiments, the functionality of 3D imaging data processor 110 may be implemented using one or more processors 145, which are coupled to one or more memory units 150. 3D imaging data processor 110 is configured to process the data as described above in order to generate data that may be provided to hogel light modulator 120.

In some embodiments, hogel light modulator is configured to receive the processed 3D imaging data from 3D imaging data processor 110 and to display the data in 3D.

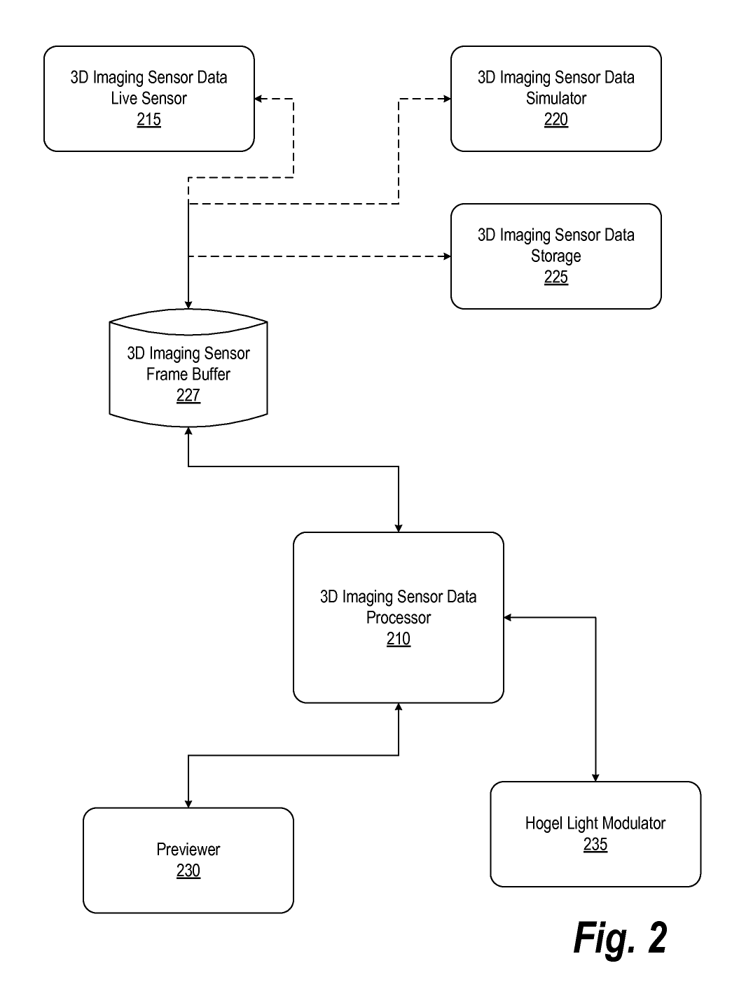

FIG. 2 is a block diagram illustrating an alternative system for processing 3D imaging sensor data, in accordance with some embodiments.

In some embodiments, 3D imaging sensor data source 215 may be configured to provide 3D imaging sensor data, 3D imaging sensor data simulator 220 may be configured to generate simulated 3D imaging sensor data, and 3D imaging sensor data storage 225 may be configured to store and provide 3D imaging sensor data. The 3D imaging sensor data may point cloud data, for example.

3D imaging sensor frame buffer 227 is configured to temporarily buffer the 3D imaging sensor data as described above and 3D imaging data processor 210 is configured to receive and process 3D imaging data. 3D imaging data processor 110 is configured to process the data as described above in order to generate data that may be provided to hogel light modulator 235.

Previewer 230 is configured to show in a 2D display a preview of the 3D data.

In some embodiments, hogel light modulator 235 is configured to receive the processed 3D imaging data and to display the data in 3D.

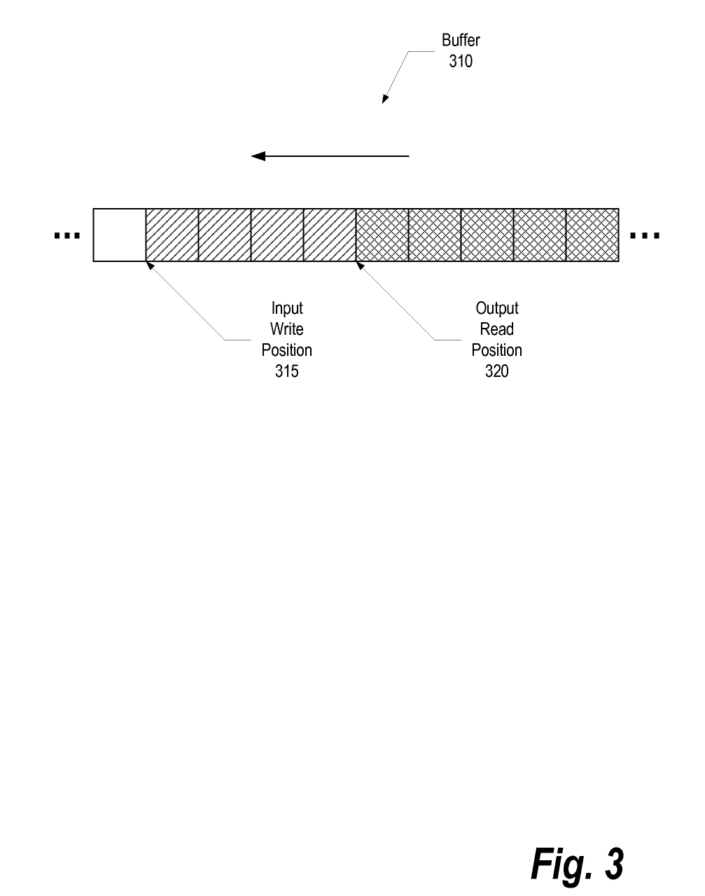

FIG. 3 is diagram illustrating a buffer for storing and retrieving 3D imaging sensor data, in accordance with some embodiments.

In some embodiments, buffer 310 is configured to be implemented as a FIFO buffer and may be further configured to receive and store 3D imaging sensor data sequentially in frames and to provide that data to one more processing threads. For example, the input thread may be configured to write into the buffer at position 315 and an output thread may be configured to read from the buffer at position 320.

In some embodiments, the buffer may be implemented as a circular buffer where the oldest values may be discarded and replaced by the newest values.

In some embodiments, the received 3D imaging sensor data may be received in sequential time frames as the data is being captured. Each of the frames may be stored in the buffer as the frames become available, with a point tracking the position where the next frame is to be stored.

One of more processing threads may each keep pointer tracking a position where each thread is reading frames from the buffer for processing. In some embodiments, the one or more processing threads may read and process one frame from the buffer at a time. In other embodiments, the processing threads may implement a sliding window in time over which the read and process data. Thus, frames read from within a sliding time windows may be averaged (and weighted if necessary) to accomplish different effects on the viewing experience. In other embodiments, various types of filters (such as a low-pass and a high-pass filter) may be applied to the sliding window.

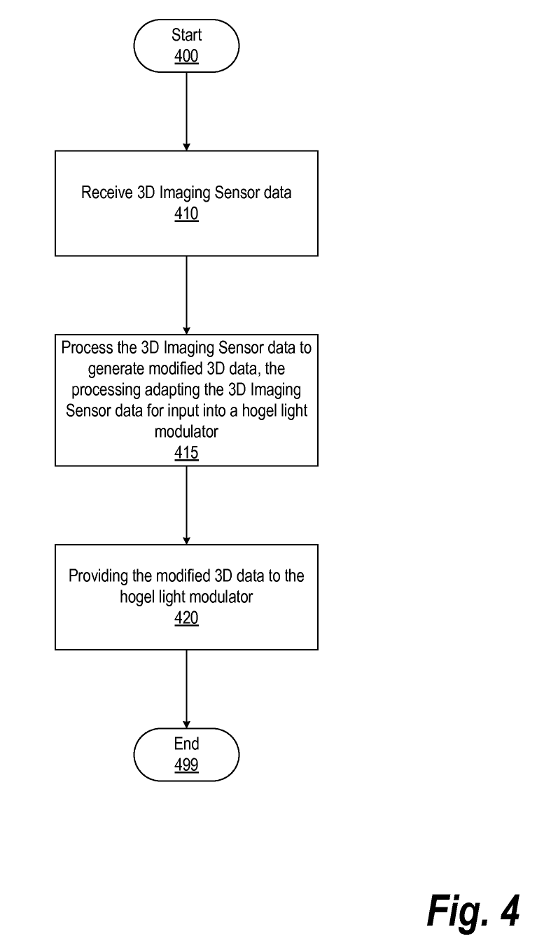

FIG. 4 is a flow diagram illustrating a method for processing 3D imaging sensor data, in accordance with some embodiments.

In some embodiments, the flowchart shown in this figure may be implemented using one or more of the systems shown in FIGS. 1-3.

Processing begins at 400 where, at block 410, 3D imaging sensor data is received.

At block 415, the 3D imaging sensor data is processed in order to generate modified 3D imaging data. The processing is configured to adapt the 3D imaging sensor data for input into a hogel light modulator.

At block 415, the modified 3D imaging data is provided to hogel light modulator for display.

Processing subsequently ends at 499.

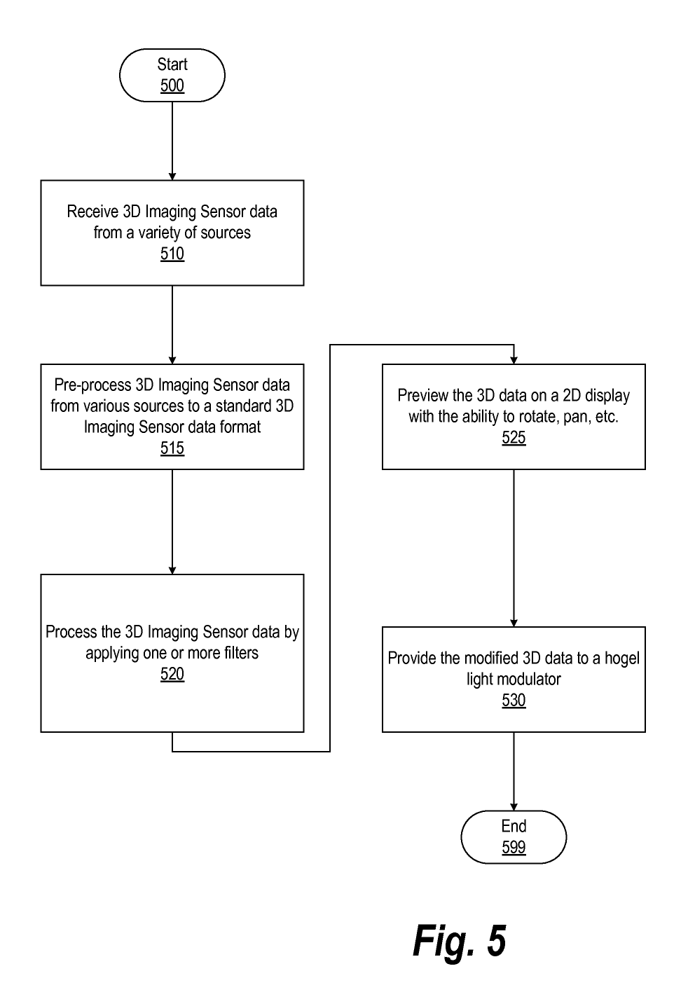

FIG. 5 is a flow diagram illustrating an alternative method for processing 3D imaging sensor data, in accordance with some embodiments.

In some embodiments, the flowchart shown in this figure may be implemented using one or more of the systems shown in FIGS. 1-3.

Processing begins at 500 where, at block 510, 3D imaging sensor data is received from one of a variety of sources.

At block 515, 3D imaging sensor data is pre-processed to a standard 3D imaging sensor data format.

At block 520, the 3D imaging sensor data is processed by applying one or more filters to the data. Examples of such filters include spatial averaging, point sorting, determination of point cloud center, time-based motion location, removing color, height shading, down-sampling, etc.

At block 525, the 3D data may be previewed on a 2D display. In some embodiments, the ability to rotate, pan, zoom, etc. the scene may be provided. In some embodiments, the view on the display may be coupled to the view on the 3D hogel light modulator.

At block 530, the modified 3D data is provided to a hogel light modulator for displaying in 3D.

Processing subsequently ends at 599.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention as detailed within the following claims.

What is claimed is:

1. A method for displaying 3D imaging sensor data, the method comprising:
providing 3D imaging sensor data;
processing the 3D imaging sensor data, the processing being configured to modify the 3D imaging sensor data into a modified format suitable for a hogel light modulator; and
providing the modified 3D imaging data to the hogel light modulator.

2. The method of claim 1, where the 3D imaging sensor data is provided in sequential time frames, the method further comprising storing each of the frames in a FIFO buffer.

3. The method of claim 2, further comprising processing the 3D imaging sensor data by reading the next frame from the buffer.

4. The method of claim 2, further comprising processing the 3D imaging sensor data by reading the next frame and one or more subsequent frames from the buffer.

5. The method of claim 1, further comprising pre-processing the scanned 3D data, where the 3D data is configured to be received from various sources having various formats, the pre-processing being configured to modify the scanned 3D data into a common format scanned 3D data, the various formats comprising a point-cloud format.

6. The method of claim 1, further comprising previewing the modified scanned 3D data on a 2D display.

7. A system for displaying 3D imaging sensor data, the system comprising:
one or more processors;
one or more memory units coupled to the one or more processors;
the system being configured to:
provide 3D imaging sensor data;
process the 3D imaging sensor data, the processing being configured to modify the 3D imaging sensor data into a modified format suitable for a hogel light modulator; and
provide the modified 3D imaging data to the hogel light modulator.

8. The system of claim 7, where the 3D imaging sensor data is provided in sequential time frames, the system being further configured to store each of the frames in a FIFO buffer.

9. The system of claim 8, the system being further configured to process the 3D imaging sensor data by reading the next frame from the buffer.

10. The system of claim 8, the system being further configured to process the 3D imaging sensor data by reading the next frame and one or more subsequent frames from the buffer.

11. The system of claim 7, the system being further configured to pre-process the scanned 3D data, where the 3D data is configured to be received from various sources having various formats, the pre-processing being configured to modify the scanned 3D data into a common format scanned 3D data, the various formats comprising a point-cloud format.

12. The system of claim 7, further comprising previewing the modified scanned 3D data on a 2D display.
